(19) United States
(12) Patent Application Publication
(10) Pub. No.: US 2010/0187705 A1
(43) Pub. Date: Jul. 29, 2010

(54) PREPARATION METHOD FOR MICRO-CAPSULE USING A MICROFLUIDIC CHIP SYSTEM

(75) Inventors: Chang-Soo LEE, Daejeon (KR); Chang-Hyung CHOI, Daejeon (KR)

Correspondence Address: Edwards Angell Palmer & Dodge LLP, P.O. Box 55874, Boston, MA, 02205, US

(73) Assignee: The Industry & Academic Cooperation in Chungnam National University (IAC), Daejeon (KR)

(21) Appl. No.: 12/508,219

(22) Filed: Jul. 23, 2009

(30) Foreign Application Priority Data
Jan. 23, 2009 (KR) 10-2009-6298

(51) Int. Cl. B29B 9/00

(52) U.S. Cl. 264/5

(57) ABSTRACT

A method for preparing microcapsules using a droplet-based microfluidic chip. Monodisperse microcapsules, which are hollow or can be loaded with a desired material, are prepared using a droplet-based microfluidic chip through the movement of a monomer molecule from the inside of droplets to the interface of droplets, the diffusion of a photoinitiator to the interface of droplets, and the suppression of radical activity by oxygen in droplets. The method involves the use of a simple microfluidic channel and selectively photopolymerizing the shell of the droplets without needing the use of a chemically treated microfluidic channel or a complex microfluidic channel.

### CROSS-REFERENCE TO RELATED APPLICATIONS

This application claims the benefit of priority from Korean Patent Application No. 10-2009-0006298 filed on Jan. 23, 2009, which application is incorporated herein by reference in its entirety.

### BACKGROUND OF THE INVENTION

1. Field of the Invention

The present invention provides a method for preparing microcapsules using a droplet-based microfluidic chip, and more particularly to a method of preparing monodisperse microcapsules, which are hollow or can be loaded with a desired material. The monodisperse microcapsules of the invention are prepared using a droplet-based microfluidic chip through the movement of a monomer molecule from the inside of droplets to the interface of the droplets, the diffusion of a photoinitiator to the interface of the droplets, and the suppression of radical activity by oxygen in the droplets.

2. Background of the Related Art

Several methods for preparing microcapsules are known in the art.

An emulsion polymerization method provides a process for preparing microcapsules by stirring a monomer-immiscible fluid as a continuous phase using an impeller to form monomer drops, and then subjecting the droplets to UV irradiation or heating to obtain microcapsules (Rob Atkin, Paul Davies, John Hardy and Brian Vincent, Macromolecules, 37, 7979-7985 (2004)). However, this method has a disadvantage in that microcapsules having various sizes are formed, and a separate separation process is required to obtain microcapsules having a desired diameter.

A deposition method provides a process of preparing hollow microcapsules by preparing a charged hydrogel template, depositing an oppositely charged polymer electrolyte on the hydrogel template several times so as to impart mechanical strength to the polymer electrolyte, and then removing the hydrogel (Huiguang Zhu, Rohit Srivastava, and Michael J. McShane, Biomacromolecules, 6, 2221-2228 (2005)). However, this process is complicated, and much time and cost are consumed to produce hollow microcapsules using this method.

Recently, droplet-based microfluidic systems have been developed and widely used as tools for preparing monodisperse beads. Using such systems, solid polymer beads can be formed by injecting two immiscible phases into a microfluidic chip having channels formed therein so as to form uniform droplets, and then subjecting the droplets to UV irradiation and/or temperature control (Shengqing Xu, Zhihong Nie, Minseok Seo, Patrick Lewis, Eugenia Kumacheva, Howard A. Stone, Piotr Garstecki, Douglas B. Weibel, Irina Gitlin, George M. Whitesides, Angewandte Chemie International Edition, 44, 724-728 (2004)). Furthermore, a double emulsion can be formed by forming droplets with another immiscible phase, thereby preparing hollow microcapsules (A. S. Utada, E. Lorenceau D. R. Link, P. D. Kaplan, H. A. Stone, D. A. Weitz, SCIENCE, 308, 22 (2005)). However, this double emulsion method for preparing microcapsules has a disadvantage in that the microfluidic channels must be selectively chemically treated or a complicated microfluidic channel structure having a combination of capillary tubes is required.

Thus, there is a need for the development of a method of preparing monodisperse microcapsules, which are hollow or have a monomer phase loaded therein, by a single process that is simple and/or cost-effective.

### SUMMARY OF THE INVENTION

It is an object of the present invention to provide a method of preparing microcapsules, which are hollow or have a monomer phase loaded therein, using a droplet-based microfluidic chip by a simple single process. The present inventors have also developed a microbead preparation system (Korean Patent Application No. 10-2008-007642), which is simpler and easier to prepare than those described in the field to which this invention belongs.

To achieve the above object, the present invention provides a method for preparing microcapsules using a droplet-based microfluidic chip, which comprises a monomer phase inlet, a continuous phase inlet, a continuous phase-monomer phase junction and a microfluidic channel, which is irradiated with UV light, and in which the continuous phase and monomer phase injected into the inlets are passed through the junction while forming fine monomer droplets, and then the monomer droplets are passed through the microfluidic channel while being cured by UV irradiation, wherein the continuous phase is hydrophobic and contains a photoinitiator which is activated by UV irradiation, and the monomer phase is hydrophilic and contains a monomer, a crosslinker and a material to be loaded.

In the present invention, each of the additives can be used at various concentrations depending on the kind thereof and the characteristics of microcapsules to be prepared. Preferably, the photoinitiator is used in an amount of 2-10 vol %, the monomer is used in an amount of 10-30 wt %, the crosslinker is used in an amount of 2-10 wt %, and the material to be loaded is used in an amount of 0.001-1 wt %.

As used herein, the term “photoinitiator” refers to a compound which is activated by UV irradiation to polymerize a monomer phase. The photoinitiator activated by UV irradiation has a property of being dissolved in the monomer phase droplets, and thus moves to the interface between the monomer phase and the continuous phase by diffusion. Meanwhile, the activity of the activated photoinitiator is suppressed by oxygen contained in the monomer phase droplets.

The monomer is a compound which is polymerized by the activated photoinitiator and moves to the interface between the monomer phase and the continuous phase in a state of monomer phase droplets.

The crosslinker is a compound which functions to crosslink a polymer which is formed by the reaction of the monomer with the photoinitiator at the interface of the monomer phase droplets.

As used herein, the term “material to be loaded” refers to a specific material which is loaded in microcapsules.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1 and 2 are conceptual cross-sectional views of a modified droplet-based microfluidic chip, which can be used in the present invention;

FIGS. 3 and 4 are conceptual perspective views showing a portion of the droplet-based microfluidic chip;

FIG. 5 is a cross-sectional view showing the dimensions of a chip used in examples of the present invention;

FIG. 6 is a conceptual view showing changes at each step of a process for preparing microcapsules according to the present invention;

FIG. 7 is a diagram showing optimized conditions for forming droplets in a droplet-based microfluidic chip;

FIG. 8 is a set of FIB milling and electron microscope photographs showing that microcapsules prepared according to the present invention have a core-shell structure;

FIG. 9 is a set of optical microscope (top) and confocal microscope (bottom) photographs showing that microcapsules prepared according to the present invention have a core-shell structure;

FIG. 10 is a graph showing the degree of dispersion of microcapsules prepared according to the present invention;

FIG. 11 is a set of optical microscope photographs showing microcapsules prepared according to the present invention dispersed in various solvents (top, Hexadecane; center, Isopropylalcohol; bottom, Water);

FIG. 12 is a graph showing that microcapsules prepared according to the present invention shrink when temperature is increased;

FIG. 13 is a graph showing the change in the diameter of microcapsules according to changes in the concentration of surfactant and the flow rate of the continuous phase;

FIG. 14 is a graph showing the change in the diameter of microcapsules according to changes in the flow rate of the monomer phase and the flow rate of the continuous phase; and

FIGS. 15A and 15B are a set of photographs showing that a target material is loaded and encapsulated in microcapsules prepared according to the present invention. FIG. 15A is a photograph showing protein-loaded microcapsules. FIG. 15B is a photograph showing quantum dot-loaded microcapsules (FIG. 15B)

### DETAILED DESCRIPTION OF THE PREFERRED EMBODIMENT

Hereinafter, the present invention is described in detail.

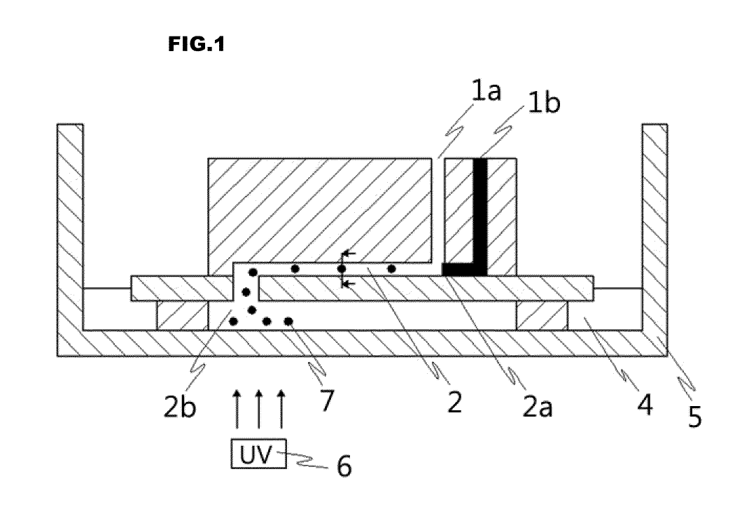

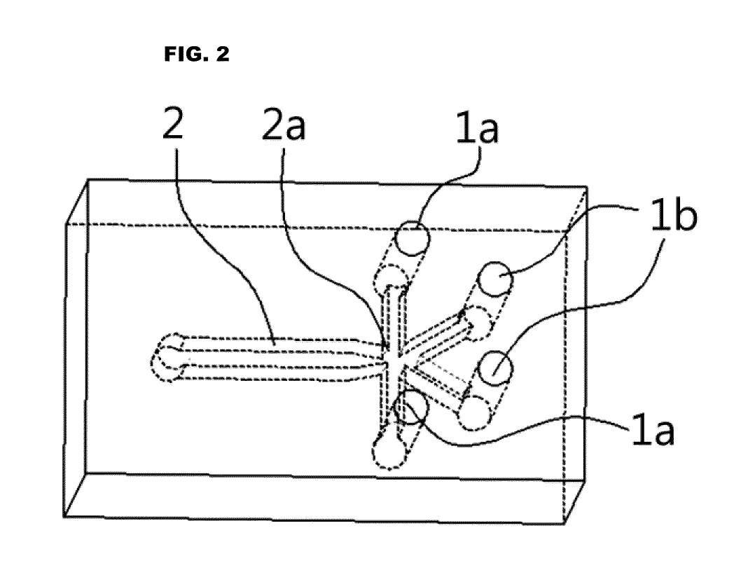

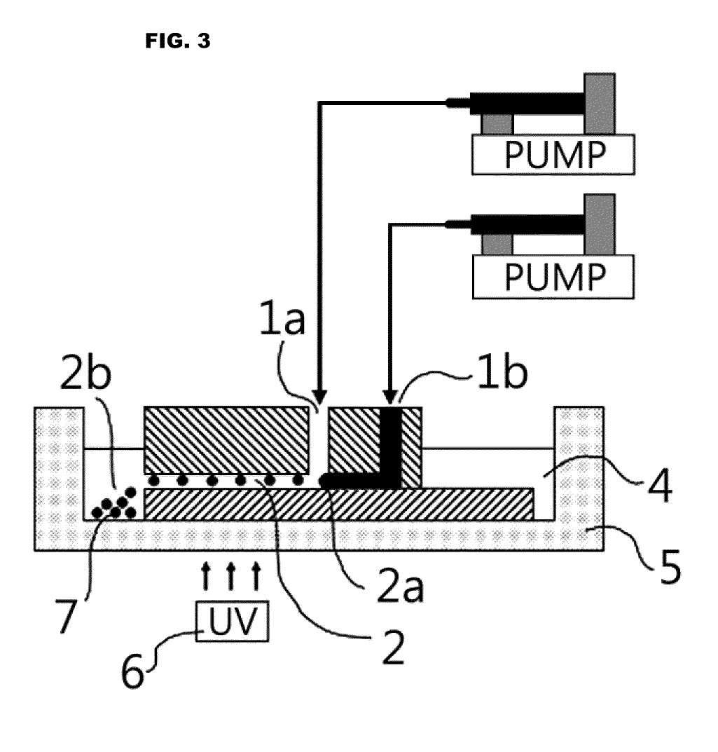

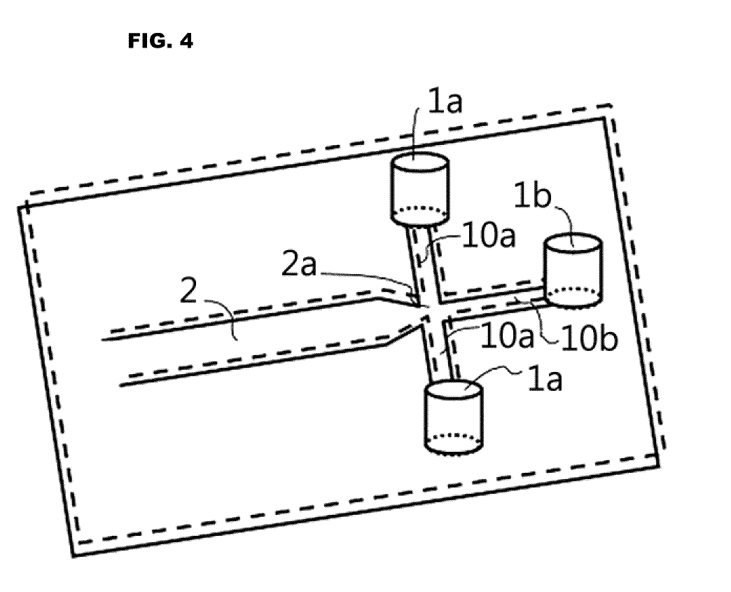

The present invention employs either the system shown in FIGS. 1 and 2 of the droplet-based microfluidic chip system shown in FIGS. 3 and 4, obtained by slightly modifying the system shown in FIGS. 1 and 2. As shown in FIG. 1, the microbead preparation system comprises a microfluidic chip, including a monomer inlet 1b, a continuous phase inlet 1a, a continuous phase-monomer junction 2a, a microfluidic channel 2 and an outlet 2b, and a water bath 5. In the microbead preparation system, a monomer injected into the monomer inlet 1b is passed through the continuous phase-monomer junction 2a to form monomer droplets, which are then passed through the microfluidic channel 2 and discharged through the outlet 2b and, at the same time, completely cured in real time by an UV irradiation device 6, thus preparing polymer microbeads.

Materials and methods for preparing the droplet-based microfluidic chip are described in detail, for example, in the specification of Korean Patent Application No. 10-2008-007642 filed by the present inventors, which is herein incorporated by reference in its entirety. A person skilled in the art with knowledge of the field to which this invention belongs can readily manufacture the droplet-based microfluidic chip using a semiconductor process with reference to the examples described below and the accompanying drawings.

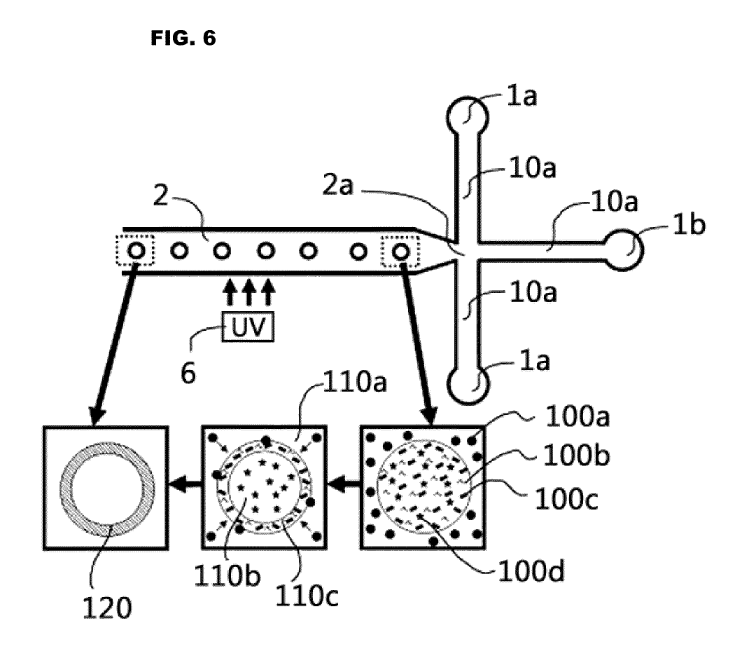

Without being limited to any particular theory, a proposed phenomenon and principle of a process for preparing microcapsules according to the present invention is now briefly described with reference to FIG. 6. In the droplet-based microfluidic chip system, a photoinitiator 100a present in a continuous phase 110a is activated using a UV irradiation device 6 in a microfluidic channel 2, which is connected with a junction 2a. The activated photoinitiator 100a diffuses to an interface 110c including a monomer 100b and a crosslinker 100c and polymerizes at the interface, thus forming a membrane 120 of a microcapsule which is hollow or loaded with a monomer phase 110b. Hereinafter, the process for preparing microcapsules is described in detail.

At the junction 2a of the chip, a water-soluble monomer phase containing the monomer 100b and the crosslinker 100c is first formed into droplets. The monomer 100b and the crosslinker 100c in the monomer phase droplets continuously move to the interface of the droplets by convection and diffusion. At the same time, the photoinitiator 100a of the continuous phase is activated by the UV irradiation device 6, and the activated photoinitiator 100a, which is dissolved in the monomer phase, moves to the interface 110c by diffusion. As a result, the monomer 100b and crosslinker 100c of the monomer phase meet the activated photoinitiator 100a of the continuous phase at the interface 110c of the droplets, and the monomer 100b is polymerized and crosslinked at the interface.

Namely, the activated photoinitiator 100a selectively polymerizes the monomer 100b at the interface, thus forming a microcapsule membrane 120 made of a polymer membrane.

Meanwhile, an oxygen molecule 100d contained in the inside (core region) of the monomer phase droplets is diffused to suppress the activity of the entering radical (activated photoinitiator), such that photopolymerization occurs only at the interface of the droplets. Herein, the content of oxygen for suppressing the activity of the radical is dependent on the content of the solvent (e.g., water) in the droplets, and thus the membrane thickness of the microcapsule can be controlled by controlling the solvent content.

The UV irradiation device 6 located at the middle portion of the microfluidic channel 2 uniformly irradiates the monomer phase droplets, which are continuously formed, with UV light, such that microcapsules are rapidly cured and the aggregation of microcapsules and/or the clogging of the channel are prevented.

In the present invention, the solvent in the continuous phase is preferably a C₁₂-C₁₈ alkane, and the solvent in the monomer phase is preferably water.

In the present invention, the photoinitiator, the monomer and the crosslinker are preferably 2,2-diethoxyacetophenone (DEAP), N-isopropylacrylamide (NIPAM), and N,N-methylenebisacrylamide (BIS), respectively.

In order to control the diameter of microcapsules which are prepared according to the present invention, a surfactant may be contained in the continuous phase. Alternatively, the injection rates of the monomer phase and the continuous phase may also be controlled. Although Span 80 was used as a surfactant in examples of the present invention, various other surfactants, including a diblock copolymer (P135), perfluorooctanoic acid, and perfluorooctanesulfonic acid, may also be used in the present invention.

In the present invention, the microcapsules preferably have, but are not limited to, a diameter of 50-85 μm and a membrane thickness of 2-3 μm.

Hereinafter, the present invention is described in further detail with reference to the accompanying drawings and examples. The drawings and examples are provided to illustratively describe the present invention, and the scope of the present invention is not limited thereto. Also, those skilled in the art will appreciate that various modifications, additions and substitutions are possible, without departing from the scope and spirit of the present invention. All publications, patent applications, patents, and other references mentioned herein are incorporated by reference in their entirety. In case of conflict, the present specification, including definitions, will control. The materials, methods, and examples are illustrative only and not intended to be limiting.

Although methods and materials similar or equivalent to those described herein can be used in the practice or testing of the present invention, suitable methods and materials are described below. It will be apparent to one skilled in the art that raw materials other than the materials used herein for experiments in the following examples (solvent for the continuous phase, solvent for the monomer, monomer-photoinitiator-crosslinker set, etc.) can be used to prepare microcapsules according to the preparation method of the present invention.

### EXAMPLES

### Example 1

### Preparation of Microcapsules

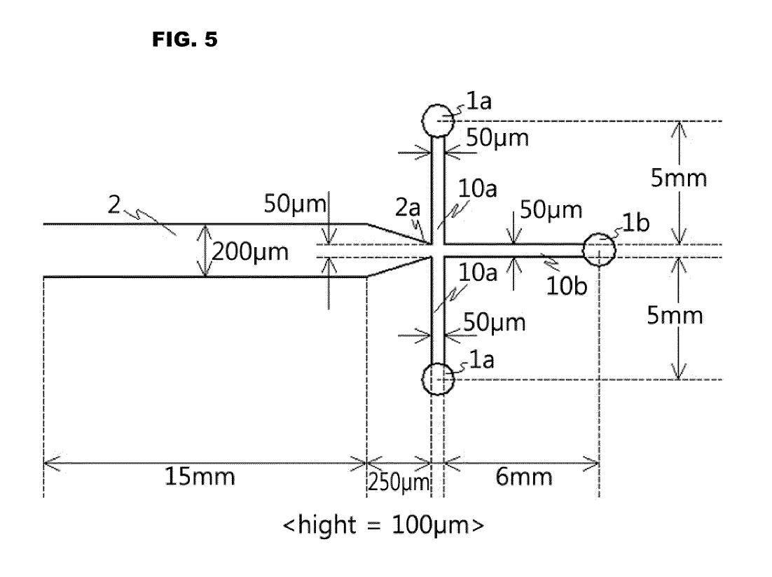

Microcapsules were prepared using a droplet-based microfluidic chip having the structure and dimensions conceptually shown in FIGS. 3, 4 and 5. For UV irradiation, a 100 W HBO mercury lamp (OSRAM) equipped with a UV filter (11000v2: UV, Chroma) was used.

As a continuous phase, a hexadecane containing 5 wt % of 2,2-diethoxyacetophenone (DEAP) as a photoinitiator was selected, and as a monomer phase, an aqueous solution containing 20 wt % of N-isopropylacrylamide (NIPAM) as a monomer and 5 wt % of N,N-methylenebisacrylamide (BIS) as a crosslinker was selected.

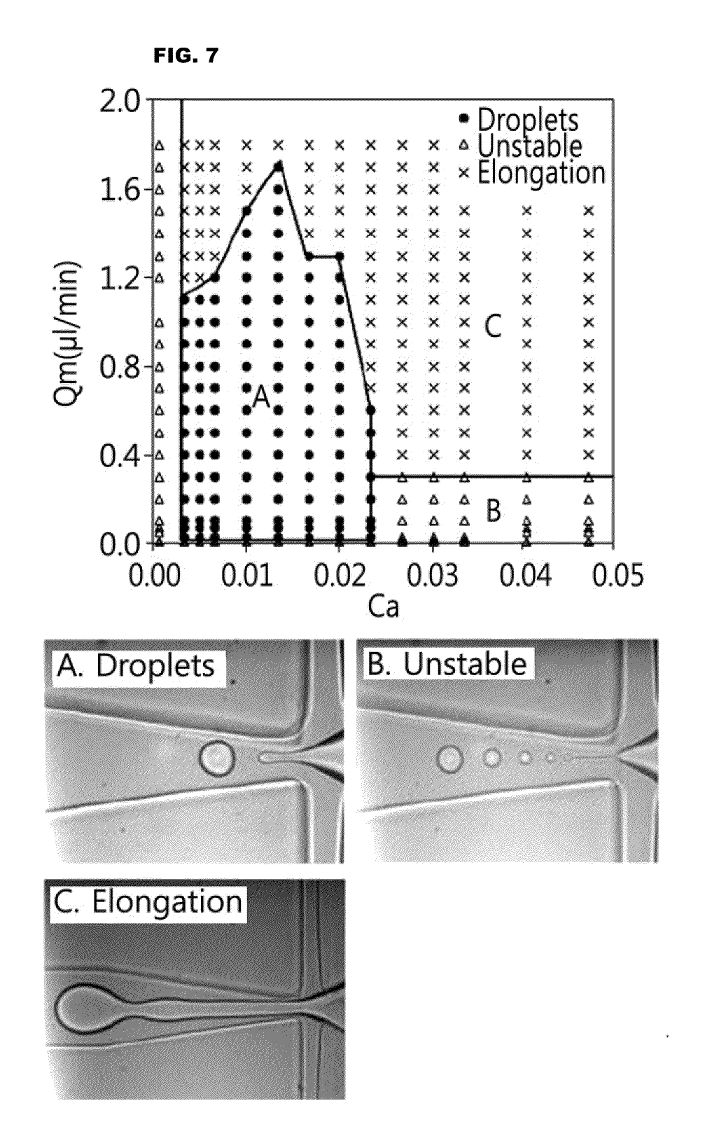

As shown in FIG. 7, when the droplet-based microfluidic chip is used, if the dimensionless capillary number (Ca) indicating the relationship between interfacial tension and viscosity, and the volumetric flow rate of the monomer phase are used as variables, the production of stable droplets is possible in specific hydrodynamic boundary conditions. According to this data, the volumetric flow rate of the continuous phase was set at 1.0-7.0 μl/min, and the volumetric flow rate of the monomer phase was set at 0.03-1.7 μl/min. These volumetric flow rates and relative volumetric flow rates will vary depending on the kind and content of raw materials used.

Microcapsules were prepared according to the above-described method.

(1) Confirmation of Microcapsules and Measurement of Membrane Thickness

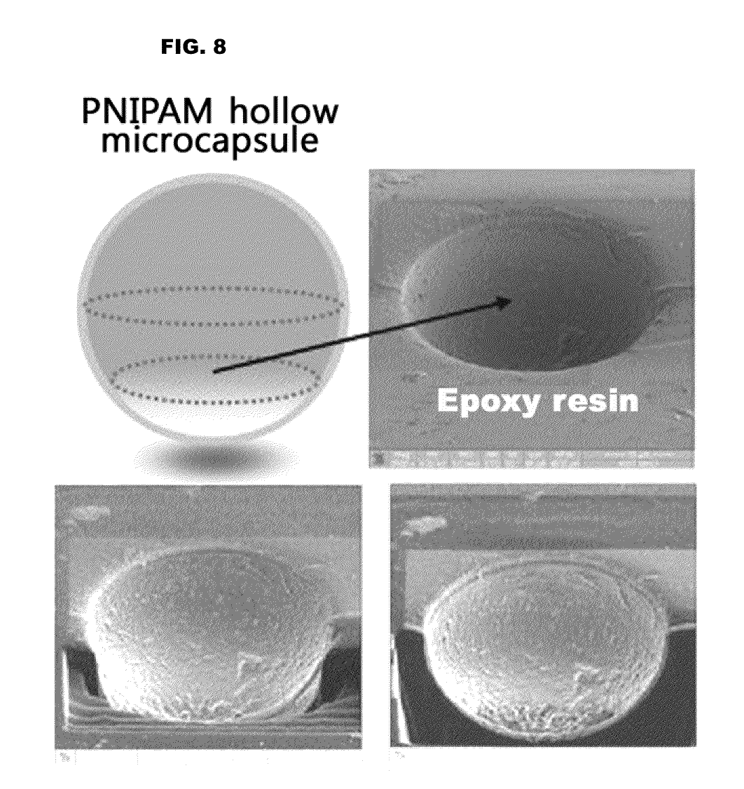

The determination of whether the final products prepared in Example 1 are microcapsules, which are hollow or can be loaded with an aqueous solution, was carried out. In order to determine the internal structure of the final product, the cross section of the product was cut according to the FIB milling method and analyzed by SEM. As a result, it was determined that the final product was a hollow capsule shape (see FIG. 8).

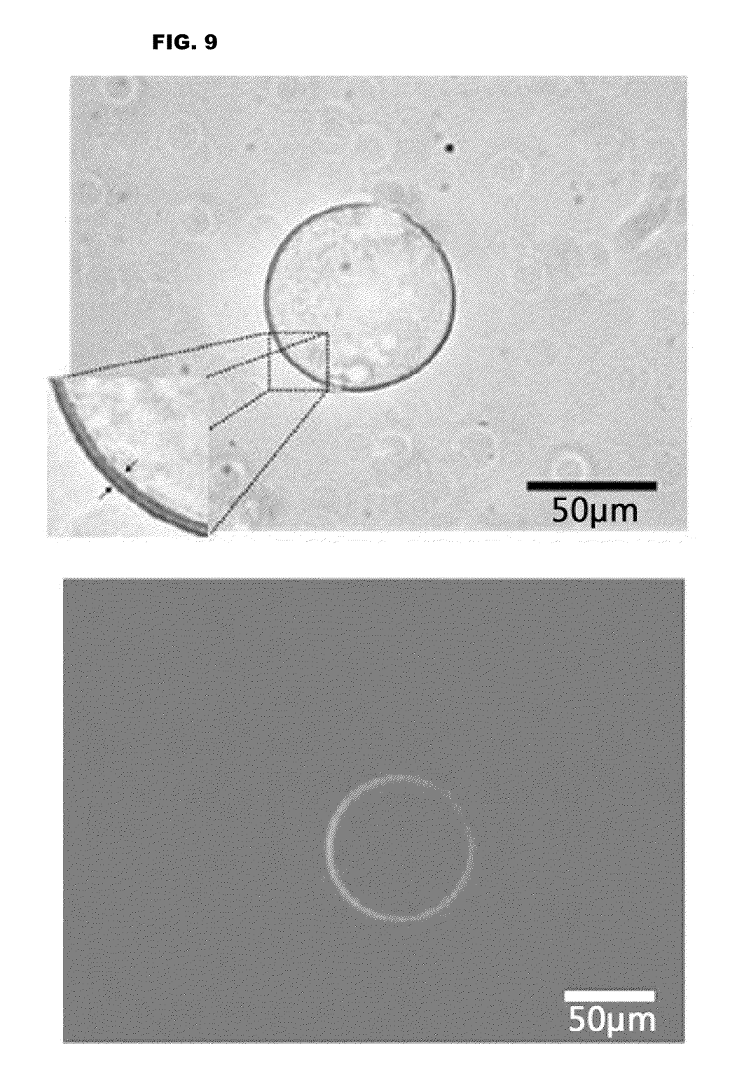

Because the final products prepared in Example 1 were determined to be microcapsules, the average diameter and average membrane thickness thereof were measured. To examine the membrane thickness of the microcapsule, the core-shell interface of the microcapsule was observed with an optical microscope and a confocal microscope (see FIG. 9).

As a result, it was determined that the final products were microcapsules having a membrane (shell) thickness of about 2 μm. However, it is to be understood that the membrane thickness of microcapsules can be controlled by suitably adjusting preparation conditions.

(2) Measurement of Degree of Dispersion of Microcapsules

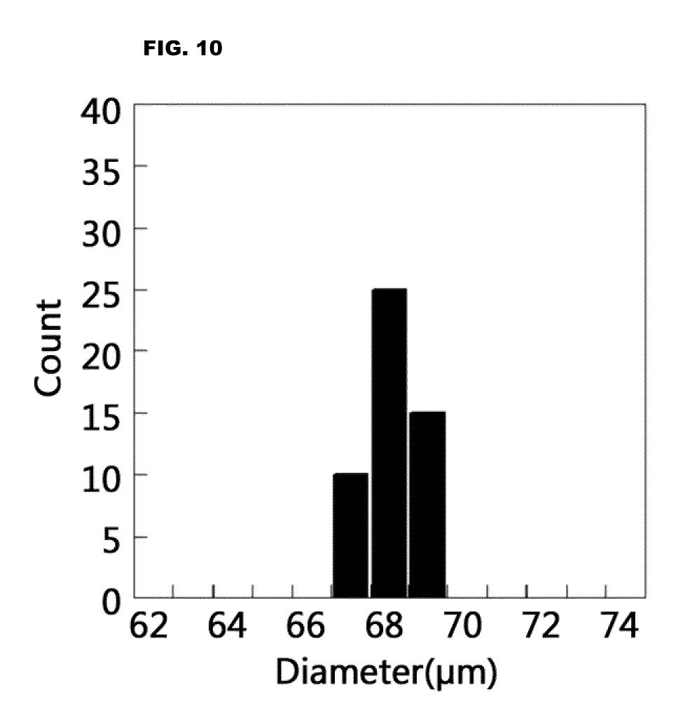

The degree of dispersion of the microcapsules prepared in Example 1 was measured by analyzing the diameter distribution of the microcapsules (see FIG. 10).

FIG. 10 is a graph showing the uniformity of the prepared microcapsules. As shown therein, most of the microcapsules had a diameter of 67-69 μm. Thus, it can be seen that microcapsules showing a high degree of monodispersity (degree of dispersion: 1.1%) can be prepared according to the present invention.

(3) Analysis of Stability of Microcapsules

The stability of the prepared microcapsules in various liquid phase environments was examined.

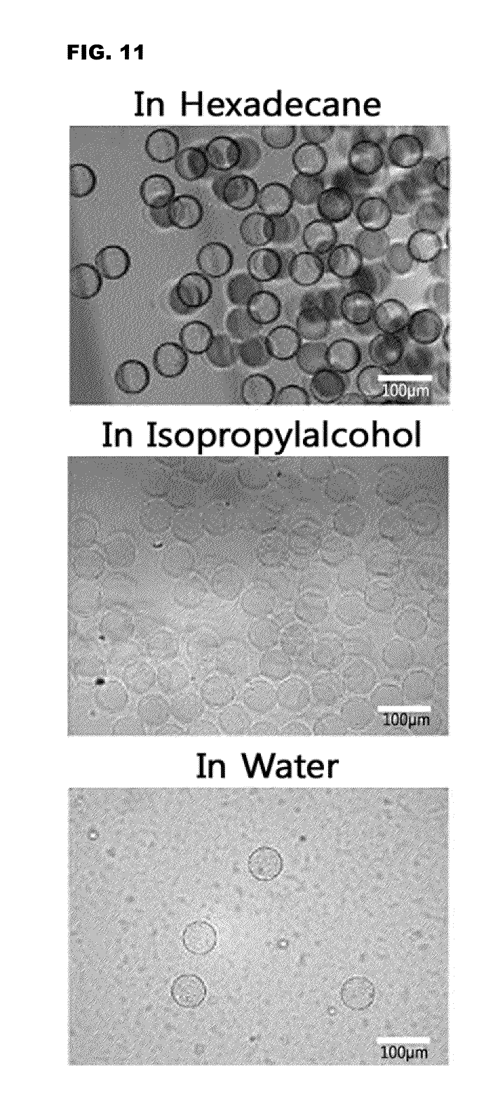

The microcapsules prepared in Example 1 were added to various solvents to determine whether the microcapsules have dispersibility. Also, to determine whether the stability of the microcapsules in the solvents, the microcapsules were kept in the solvents at 25° C. for 48 hours, and then the state of the microcapsules was analyzed (see FIG. 11).

As a result, it was determined that the microcapsules in hexadecane, isopropyl alcohol, and water dispersed well and maintained a very stable spherical shape for a long period of time.

(4) Analysis of Change in Volume of Microcapsules According to Change in Temperature

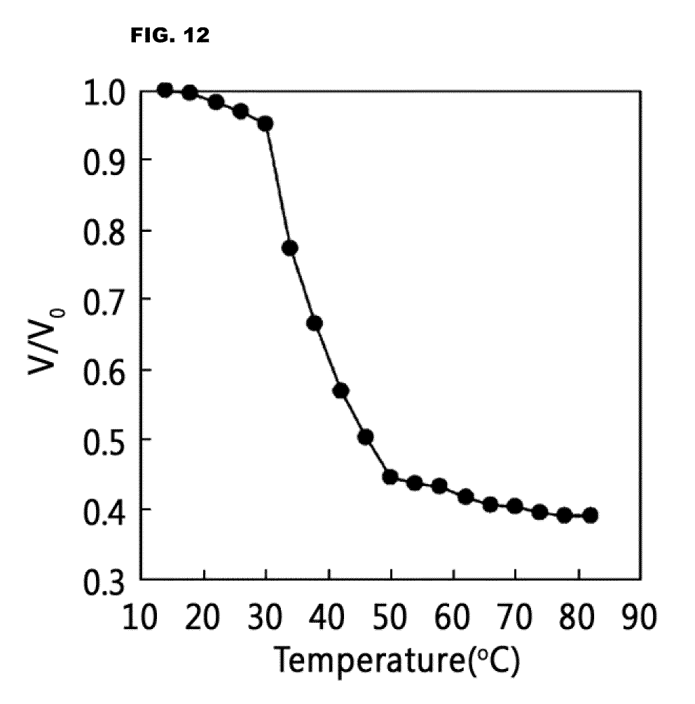

Changes in the volume of the microcapsules prepared in Example 1 according to changes in temperature was analyzed (see FIG. 12).

As can be seen in FIG. 12, a dramatic change in the volume of the microcapsules prepared in Example 1 occurred at about 32° C. Without being limited to a particular theory, this is thought to be attributable to the characteristic properties of poly(N-isopropylacrylamide) (PNIPAM). PNIPAM has a hydrophilic nature below the lower critical solution temperature (LCST; 32° C.) and swells. Above the LCST, PNIPAM becomes hydrophobic and shrinks.

### Example 2

### Control of Diameter of Microcapsules

(1) Control of Diameter of Microcapsules by Addition of Surfactant

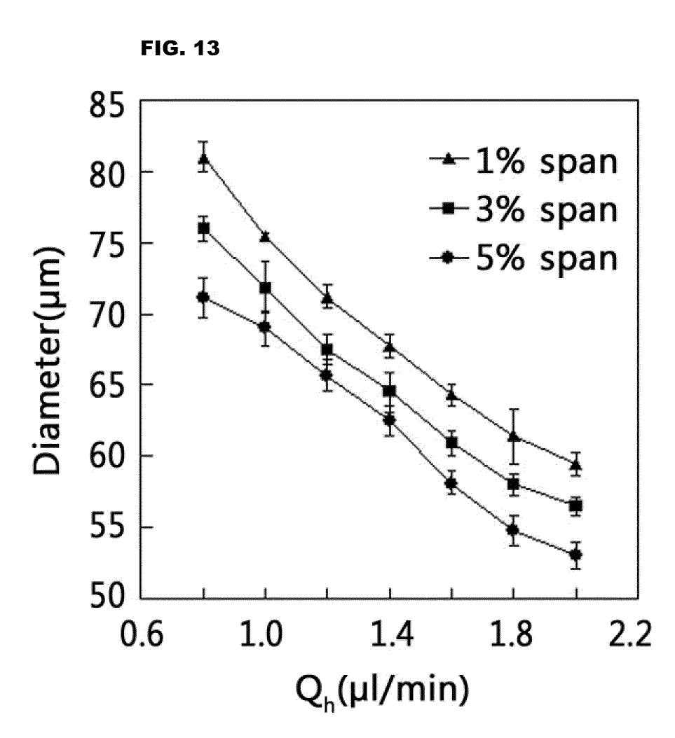

In the process of preparing the microcapsules, a surfactant (SPAN 80) was added to the continuous phase, and the diameters of the microcapsules according to concentrations (1, 3 and 5 wt %) of surfactant added and volumetric flow rate of the continuous phase were examined (see FIG. 13). Herein, the volumetric flow rate of the monomer phase was set at 0.03 μl /min.

As can be seen in FIG. 13, the diameter of the microcapsules decreased as the volumetric flow rate of the continuous phase increased and the amount of surfactant added increased. Without being limited to a particular theory, this is thought to be because the interfacial tension between the continuous phase and the monomer phase decreases with an increase in the concentration of the surfactant, so that the fluid thread is slender, and at the same time, smaller droplets are induced by the shear force of the continuous phase.

(2) Control of Diameter of Microcapsules by Control of Volumetric Flow Flux of the Continuous Phase

Without being limited to a particular theory, it is believed that the increase in the volumetric flow rate of the continuous phase induces a stronger shear force and/or increases the volume fraction per unit time, such that smaller microcapsules are formed. Similarly, without being bound to a particular theory, an increase in the volumetric flow rate of the monomer phase increases the volume fraction per unit time to induce larger microcapsules.

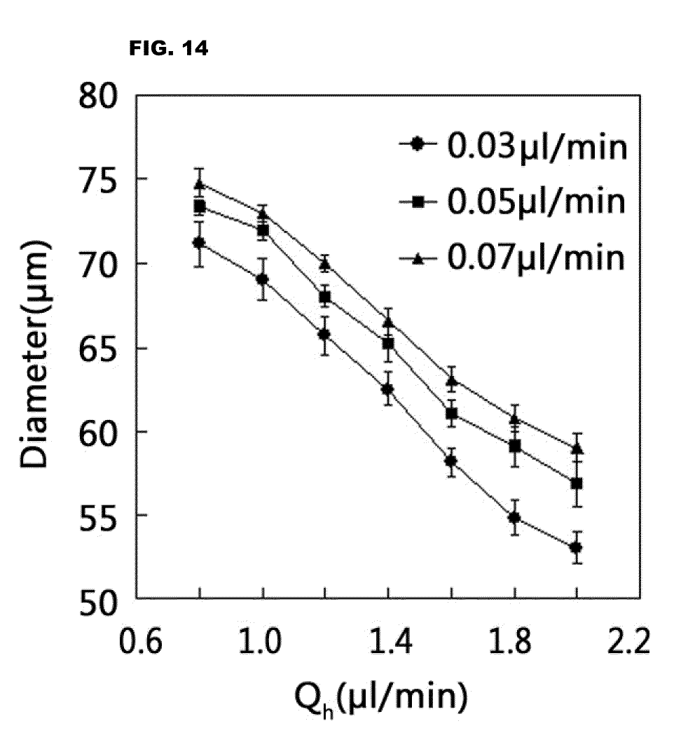

In order to confirm these points, in the process of preparing the microcapsules, the volumetric flow rate of the monomer phase was set at 0.03, 0.05 and 0.07 μl/min, and the change in the diameter of the microcapsules according to the change in the volumetric flow rate of the continuous phase was analyzed (see FIG. 14).

As can be seen in FIG. 14, the diameter of the microcapsules decreased as the volumetric flow rate of the continuous phase increased and the volumetric flow rate of the monomer phase decreased.

### APPLICATION EXAMPLE

Microcapsules were prepared in the same condition and manner as in Example 1, except that material to be loaded was added to the monomer phase: (1) protein FITC-BSA (fluorescein isothiocyanate-conjugated bovine serum albumin; FITC (excitation/emission: 496 nm/521 nm)) in an amount of 100 μg per ml of the monomer phase or (2) mercaptoacetic acid-capped quantum dots (excitation/emission: 595 nm/610 nm) in an amount of 10 μg per ml of the monomer phase.

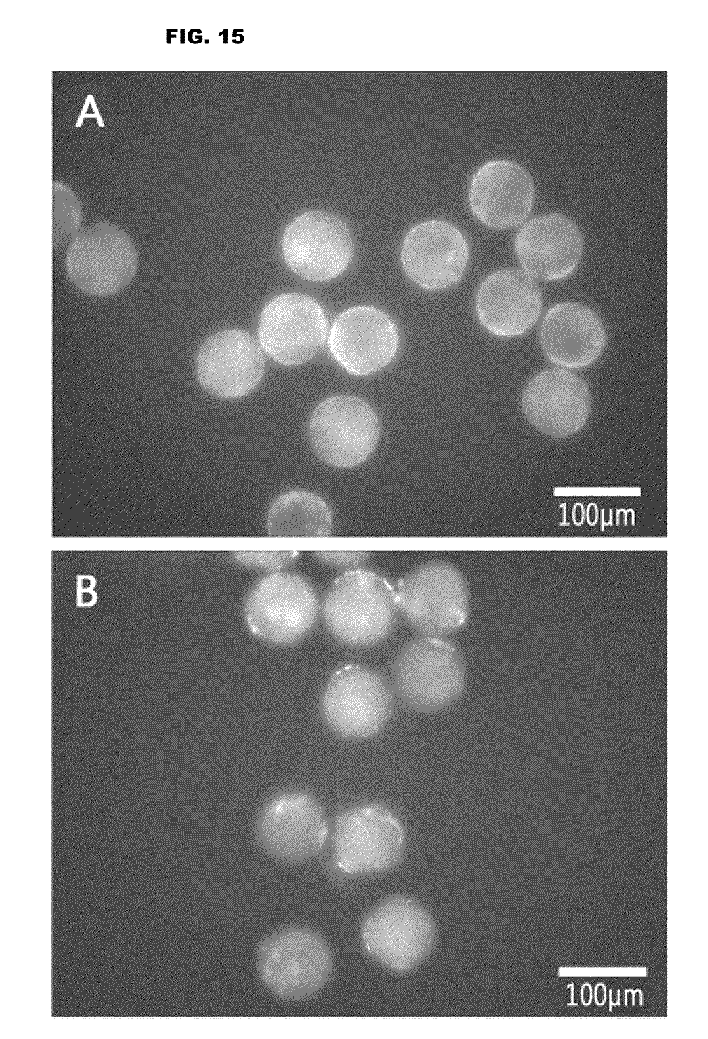

The prepared microcapsules were illuminated with UV light and photographed by fluorescence microscopy (see FIG. 15). As can be seen in FIG. 15, the protein-loaded microcapsules (FIG. 15A) and the quantum dot-loaded microcapsules (FIG. 15B) showed green fluorescence and red fluorescence, respectively, and no fluorescence was observed in the background. This suggests that the desired materials were effectively loaded into the microcapsules.

Thus, according to the method of the present invention, a desired drug or a biomolecule can be easily loaded into microcapsules. The microcapsules thus prepared can be used in a wide range of applications, including drug delivery systems and microreactors.

As described above, according to the present invention, microcapsules which are hollow or have a monomer phase loaded therein can be prepared by forming droplets using a microfluidic chip including a simple microfluidic channel, inducing the movement of a monomer from the inside of the droplets to the interface of the droplets and selectively photopolymerizing the shell of the droplets, without needing to use a chemically treated microfluidic channel or a complex microfluidic channel.

According to the present invention, a useful biomolecule or drug is encapsulated by forming droplets after simply mixing the biomolecule or drug with a monomer, and thus can be conveniently applied to drug delivery systems.

In addition, according to the present invention, the size of droplets can be freely controlled by controlling the flow rate ratio between the continuous phase and the monomer phase in the microfluidic chip in real time through the control of a pump. Thus, microcapsules having the desired diameter and membrane thickness can be economically produced.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A method for preparing microcapsules using a droplet-based microfluidic chip, which comprises a monomer phase inlet, a continuous phase inlet, a continuous phase-monomer phase junction and a microfluidic channel, which is irradiated with UV light, and in which the continuous phase and monomer phase injected into the inlets are passed through the junction while forming fine monomer droplets, and then the monomer droplets are passed through the microfluidic channel while being cured by UV irradiation,
wherein the continuous phase is hydrophobic and contains a photoinitiator which is activated by UV irradiation, and the monomer phase is hydrophilic and contains a monomer, a crosslinker and a material to be loaded.

2. The method of claim 1, wherein a solvent in the continuous phase is a C₁₂-C₁₈ alkane, and a solvent in the monomer phase is water.

3. The method of claim 1, wherein the photoinitiator, the monomer, and the crosslinker are 2,2-diethoxyacetophenone (DEAP), N-isopropylacrylamide (NIPAM), and N,N-methylenebisacrylamide (BIS), respectively.

4. The method of claim 1, wherein the continuous phase additionally contains a surfactant.

5. The method of claim 1, wherein the diameter of the microcapsules is controlled by controlling the injection rates of the monomer phase and the continuous phase.

6. The method of claim 1, wherein the microcapsules have a diameter of 50-85 μm and a membrane thickness of 2-3 μm.
